(19) United States
(12) Patent Application Publication
(10) Pub. No.: US 2002/0142203 A1
(43) Pub. Date: Oct. 3, 2002

(54) Refuelable metal air electrochemical cell and refuelabel anode structure for electrochemical cells

(76) Inventors: Fuyuan Ma, Yorktown Heights, NY (US); Muguo Chen, South Salem, NY (US); Tsepin Tsai, Chappaqua, NY (US); Wenbin Yao, Fair Lawn, NJ (US); Sadeg Faris, Pleasantville, NY (US); Lin-Feng Li, Croton, NY (US)

Correspondence Address: eVionyx, Inc., 85 Executive Blvd., Elmsford, NY, 10523, US

(21) Appl. No.: 10/094,672

(22) Filed: Mar. 8, 2002

Related U.S. Application Data
(60) Provisional application No. 60/274,337, filed on Mar. 8, 2001.
(60) Provisional application No. 60/274,274, filed on Mar. 8, 2001.

(51) Int. Cl. H01M 2/14; H01M 4/62; H01M 12/06

(52) U.S. Cl. 429/27; 429/246; 429/212

(57) ABSTRACT

A refuelable anode structure containing anode paste for a metal air electrochemical cell is provided. The anode paste comprises metal particles, a gelling agent, and a base. The spent anode structure may be removed after discharging. The anode structure may thereafter be electrically recharged to convert oxidized metal into consumable metal fuel, or mechanically emptied and refilled with fresh metal fuel paste.

### RELATED APPLICATIONS

The present application claims priority to Unites States Provisional Patent Application Serial No. 60/274,337 entitled “Refuelable Metal Air Electrochemical Cell and Anode Paste for Electrochemical Cells” filed on Mar. 8, 2001 by Fuyuan Ma, Muguo Chen, Tsepin Tsai, Sadeg M. Faris, Lin-feng Li, and James Wilson, and Unites States Provisional Patent Application Serial No. 60/274,274 entitled “Interfacial Material for Electrochemical Cells” by Fuyuan Ma, Muguo Chen, Tsepin Tsai and Wayne Yao, the entire disclosures of which are both incorporated herein by reference in their entireties.

### BACKGROUND OF THE INVENTION

1. Field of the Invention

The present invention relates to metal air electrochemical cells. More particularly, the invention relates to refuelable metal air electrochemical cells and anodes paste for use therewith.

2. Description Of The Prior Art

Electrochemical power sources are devices through which electric energy can be produced by means of electrochemical reactions. These devices include metal air electrochemical cells such as zinc air and aluminum air batteries. Such metal electrochemical cells employ an anode comprised of metal particles that are fed into the cell and consumed during discharge. Certain electrochemical cells are, for example, mechanically rechargeable or refuelable, whereby the consumable anode is replaced for continued discharge. Zinc air refuelable cells include an anode, a cathode, and an electrolyte. The anode is conventionally formed of zinc plates or a slurry of zinc particles immersed in electrolyte. The cathode generally comprises a semipermeable membrane and a catalyzed layer for reducing oxygen. The electrolyte is usually a caustic liquid that is ionic conducting but not electrically conducting.

Metal air electrochemical cells have numerous advantages over traditional hydrogen-based fuel cells. In particular, the supply of energy provided from metal air electrochemical cells is virtually inexhaustible because the fuel, such as zinc, is plentiful and can exist either as the metal or its oxide. Further, solar, hydroelectric, or other forms of energy can be used to convert the metal from its oxide product back to the metallic fuel form. The fuel of the metal air electrochemical cells may be solid state or in the form of a paste, therefore, it is generally safe and easy to handle and store. In contrast to hydrogen-oxygen electrochemical cells, which use methane, natural gas, or liquefied natural gas to provide as source of hydrogen, and potentially emit polluting gases, the metal air electrochemical cells results in zero emission. The metal air fuel cell batteries operate at ambient temperature, whereas PEM hydrogen-oxygen fuel cells typically operate at temperatures in the range of 50° C. to 200° C. Generally, metal air electrochemical cells are capable of delivering higher output voltages (1-3 Volts) than conventional fuel cells (<0.8V).

One of the principle obstacles of metal air electrochemical cells is the prevention of leakage of the electrolyte, typically a liquid electrolyte. Another obstacle relates to refueling of the anode.

It is a known practice to produce electrodes made of zinc powder in the form of a suspension in a gel. The gels used include the electrolyte and a gelling agent in the form of a linear chain such as starch, compounds of carboxymethyl cellulose (CMC), or the like.

U.S. Pat. No. 3,871,918 to Viescou discloses an electrochemical cell embodying an electrode of zinc powder granules suspended in an electrolyte gel. Other zinc anodes are formed from powdered zinc which is sintered or wetted and pressed into a plate. The sedimentation of zinc was prevented by holding the grains of zinc in a gel constituted by a polymerization of acrylamide, acrylic acid and methylenebisacrylamide. Such a system is not refuelable. Further, illustrative embodiments therein employ mercury in the gel.

U.S. Pat. No. 4,842,963 to Ross describes a configuration and associated system for a rechargeable zinc air battery wherein electrolyte is recirculated through an external pump and electrolyte reservoir. Such a recirculatory system consumes substantial energy, and additional weight is also added to the cell due to the pump.

U.S. Pat. No. 4,147,839 to Solomon et al. describes a zinc anode in the form of slurry. Refueling is accomplished by stirring the slurry, and spent material is emptied either by pressure or vacuum. A stirring means located within the electrolyte chamber must be maintained to keep the active metal powder fluidized. This system, as in the other past systems described herein, draws energy from the system with external pumps and the like.

U.S. Pat. No. 5,006,424 to Evans discloses supplying electrolyte and zinc particles to an anode. Spent electrolyte and zinc particles are removed with a vacuum probe. This system is not suitable for small applications, such as portable electronics, and consumes power through one or more external pumps.

U.S. Pat. No. 5,849,427 to Siu et al. describes refueling a zinc anode through hydraulic replacement of spent electrolyte and zinc particles. After a sufficiently deep discharge, the reacted particles generally stick together. The particles are removed when they are flushed with a large quantity of liquid such as water or electrolyte. Also described is a method of refueling a zinc anode by electrically recharge the cell through using a bifunctional air cathode. However, electrolyte must be recirculated in this system. This system is complicated, consumes power through one or more pumps, and not suitable for small applications, such as portable electronics.

U.S. Pat. No. 5,592,117 to Colborn et al. describes a method of refueling by detaching a transportable container with the spent electrolyte and reacted products. However, this method still requires a pump to fill electrolyte.

Another obstacle of metal air electrochemical cells relates to electrolyte wetting of the cathode. An air-cathode generally comprises an active layer of activated carbon, a catalyst, and a binder, which forms a network that holds the carbon together. Embedded within the active layer is a metal current collector. A guard layer, which is generally a semi-permeable membrane, covers the surface of the active layer that faces the outside air, and typically serves to prevent electrolyte from leaking from the cell. Electrochemical reactions occur at the three-phase region. Oxygen diffuses through the guard layer from outside of the cell and reduces at the catalyzed layer. To prevent aqueous electrolyte leaking and, at the same time, to permeate air into the cell, fluoropolymer-bonded catalysts and hydrophobic cathode composite structures are usually adopted (David Linden, editor in chief, Handbook of Batteries, 2nd. (1995), p 13.1). The hydrophobic characteristic of the cathode is important in order to help prevent saturation or flooding of the cathode with electrolyte, since such flooding would effectively reduce the amount of air reaching the cathode for electrochemical depolarization. Because of the hydrophobic characteristic of cathode, a new cathode usually cannot discharge right away, or alternatively, the initial discharging current is very low. Therefore, a so-called “activation process” is typically required to suitably “wet” the cathode surface, which starts at a relatively low current and is increased gradually until a stable discharging voltage is obtained. Such a process sometimes takes a very long time (e.g., up to a few hours).

U.S. Pat. No. 5,993,989 to Baozhen et al. relates to an interfacial layer of terbia-stabilized zirconia between an air cathode and electrolyte in a solid oxide fuel cell. The layer is described as providing a barrier that controls interaction between the air cathode and the electrolyte, and also reduces the electrical resistance between the air cathode/electrolyte interface.

U.S. Pat. No. 4,692,274 to Isenberg et al. teaches an interlayer material, which is electrically conductive and oxygen permeable, between a cathode and an electrolyte to protect the cathode material from hot metal halide vapor attack in a hydrogen-oxygen fuel cell.

U.S. Pat. No. 4,585,710 to McEvoy teaches application of a gelling material between the cathode active layer and the separator layer to strengthen the adhesion between the separator and the cathode thereby preventing delamination and providing an electrolyte reservoir for the hydrophobic cathode.

There remains a need in the art for an improved refuelable metal air electrochemical cell, particularly one using an anode paste as the consumable material. Further, there remains a need in the art for an improved interface between the cathode and the anode of metal air electrochemical cells, particularly for refuelable metal air electrochemical cells.

### SUMMARY OF THE INVENTION

The above-discussed and other problems and deficiencies of the prior art are overcome or alleviated by the several methods and apparatus of the present invention, wherein a refuelable anode structure containing anode paste for a metal air electrochemical cell is provided. The anode paste comprises metal particles, a gelling agent, and a base. The spent anode structure may be removed after discharging. The anode structure may thereafter be electrically recharged to convert oxidized metal into consumable metal fuel, or mechanically emptied and refilled with fresh metal fuel paste.

The above-discussed and other features and advantages of the present invention will be appreciated and understood by those skilled in the art from the following detailed description and drawings.

### BRIEF DESCRIPTION OF THE DRAWINGS

Numerous other advantages and features of the present invention will become readily apparent from the following detailed description of preferred embodiments when read in conjunction with the accompanying drawings, wherein:

FIG. 1 is a schematic representation of an embodiment of a metal air electrochemical cell;

FIG. 2 is an isometric view of an embodiment of an anode chamber;

FIG. 3 is a schematic representation of another embodiment of a metal air electrochemical cell;

FIG. 4 is a schematic representation of still another embodiment of a metal air electrochemical cell;

FIG. 5 is a schematic representation of another embodiment of a metal air electrochemical cell, wherein a third electrode is provided; and

FIG. 6 shows an exemplary bipolar metal air electrochemical cell using an anode chamber.

### DETAILED DESCRIPTION OF THE ILLUSTRATIVE EMBODIMENTS

A mechanically rechargeable or refuelable anode structure containing an anode paste for a metal air electrochemical cell is provided. The anode paste comprises metal particles, a gelling agent, and a base. The spent anode structure may be removed after discharging. The anode structure may thereafter be electrically recharged to convert oxidized metal into consumable metal fuel, or mechanically emptied and refilled with fresh metal fuel paste.

Referring now to the drawings, an illustrative embodiment of the present invention will be described. For clarity of the description, like features shown in the figures shall be indicated with like reference numerals and similar features as shown in alternative embodiments shall be indicated with similar reference numerals.

FIG. 1 is a schematic representation of an electrochemical cell 10. Electrochemical cell 10 may be a metal oxygen cell, wherein the metal is supplied from a removable and replaceable metal anode structure 12 and the oxygen is supplied to an oxygen cathode 14 (e.g., within a suitable cathode structure configured and dimensioned to hold the anode structure 12). The removable and replaceable anode structure 12 and the cathode 14 are maintained in electrical isolation from one another by a separator 16. An alkaline electrolyte may be provided as an anode constituent as described herein only, in combination with a separator capable of holding electrolyte as described herein, or optionally an external electrolyte in gel or liquid form may be provided in the cell 10. The shape of the cell and of the components therein is not constrained to be square or rectangular; it can be tubular, circular, elliptical, polygonal, or any desired shape. Further, the configuration of the cells components, i.e., vertical, horizontal, or tilted, may vary, even though the cell components are shown as substantially vertical in FIG. 1.

Oxygen from the air or another source is used as the reactant for the air cathode 14 of the metal air cell 10. When oxygen reaches the reaction sites within the cathode 14, it is converted into hydroxyl ions together with water. At the same time, electrons are released to flow as electricity in the external circuit. The hydroxyl travels through the separator 16 to reach the metal anode 12. When hydroxyl reaches the metal anode (in the case of an anode 12 comprising, for example, zinc as the metal fuel), zinc hydroxide is formed on the surface of the zinc. Zinc hydroxide decomposes to zinc oxide and releases water back to the alkaline solution. The reaction is thus completed.

The anode reaction is:

Zn+4OH⁻→Zn(OH)₄²⁻2e (1)

Zn(OH)₄²⁻→ZnO+H₂O+2OH⁻ (2)

The cathode reaction is:

½O₂+H₂O+2e→2OH⁻ (3)

Thus, the overall cell reaction is:

Zn+½O₂→ZnO (4)

The removable anode structure 12 comprises a housing having a metal fuel anode paste therein. The anode paste generally comprises a metal constituent and an ionic conducting medium. In certain embodiments, the ionic conducting medium comprises an electrolyte, such as an aqueous electrolyte, and a gelling agent. In other embodiments, the ionic conducting medium comprises a solid or substantially solid electrolyte. Preferably, the formulation optimizes ion conduction rate, density, and overall depth of discharge, while minimizing water leakage from the housing, and more preferably eliminating such water leakage.

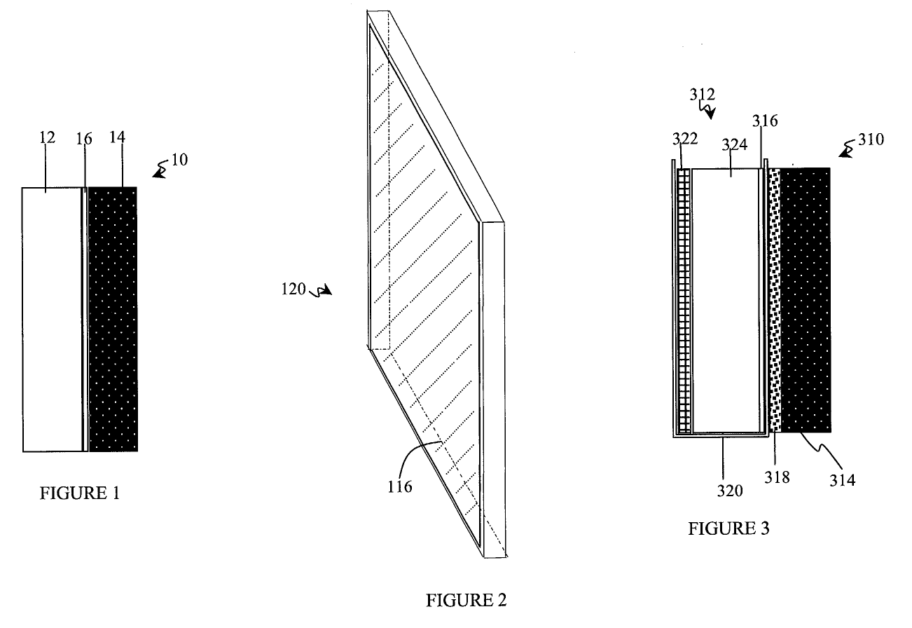

The housing is any suitable structure configured and dimensioned for the cell configuration and required capacities of the cell. One suitable structure is illustrated in FIG. 2, wherein a housing 120 is provided. For example, in cells having contact areas of about 30 cm², suitable thickness are about 0.1 cm to about 3 cm, preferably about 0.3 cm to about 1-3 cm. Larger contact areas may have thicker cells, depending on the desired discharge characteristics. The housing may have a separator attached to one major surface, as shown in FIG. 2, which is intended to be in contact with the cathode. Alternatively, a separator may be disposed on two major surfaces, for example, in a bipolar cell configuration, an example of which is shown in FIG. 6 and described further herein. Regardless of the type of cell (i.e., monopolar or bipolar), the housing for the anode paste is configured and dimensioned to conveniently hold anode paste to allow for easy removal of spent material (by removal of the housing itself). Thus, the housing has suitable sidewalls and a bottom portion, to hold the anode paste in a box or trough for convenience. Such a configuration is in stark contrast to conventional refuelable metal air cells, wherein a solid card or a loose anode paste is used as the consumable metal fuel.

As described above, a separator 116 is provided on a surface of the housing 120, for example, for placement adjacent to the cathode 14. The separator 116 may be disposed on an inside or outside surface of the housing 120. Examples of suitable separators are described herein.

Various materials may be used for the housing 120, which are preferably inert to the system chemicals. Such materials include, but are not limited to, thermoset, thermoplastic, and rubber materials such as polycarbonate, polypropylene, polyetherimide (e.g. ULTEM® 1000 commercially available from General Electric Company, Pittsfield, Mass.), polysulfone, polyethersulfone, and polyarylether ketone (PEEK), VITON® (commercially available from E.I. duPont de Nemours and Company, Wilmington, Del.), ethylenepropylenediene monomer, ethylenepropylene rubber, and mixtures comprising at least one of the foregoing materials.

The metal constituent of the anode paste may comprise mainly oxidizable metals such as zinc, calcium, lithium, magnesium, ferrous metals, aluminum, and combinations and alloys comprising at least one of the foregoing metals. These metals may also be alloyed with constituents including, but not limited to, bismuth, indium, lead, mercury, gallium, tin, cadmium, molybdenum, tungsten, chromium, vanadium, germanium, arsenic, antimony, selenium, tellurium, strontium. Preferably, the metal constituent of the anode comprises zinc or combinations and alloys comprising zinc. During conversion in the electrochemical process, the metal is generally converted to a metal oxide. The metal constituent generally comprises about 30% to about 90% of the anodes paste, preferably about 30% to about 80%, and more preferably about 40% to about 70%.

The electrolyte generally comprises alkaline media to reach the metal anode. An ion conducting amount of electrolyte is provided in anode 12. Alternatively, electrolyte is also incorporated in a gel between the anode 12 and the cathode 14. Preferably, sufficient electrolyte is provided to maximize the reaction and depth of discharge. The electrolyte generally may comprise ionic conducting materials such as KOH, NaOH, other caustic materials, or a combination comprising at least one of the foregoing electrolyte media. Particularly, the electrolyte may be in the form of alkaline solutions, polymer-based solid gel membranes, or any combination comprising at least one of the foregoing forms. Exemplary electrolytes are disclosed in copending, commonly assigned: U.S. Pat. No. 6,183,914, entitled “Polymer-based Hydroxide Conducting Membranes”, to Wayne Yao, Tsepin Tsai, Yuen-Ming Chang, and Muguo Chen, filed on Sep. 17, 1998; U.S. patent application Ser. No. 09/259,068, entitled “Solid Gel Membrane”, by Muguo Chen, Tsepin Tsai, Wayne Yao, Yuen-Ming Chang, Lin-Feng Li, and Tom Karen, filed on Feb. 26, 1999; U.S. patent application Ser. No. 09/482,126 entitled “Solid Gel Membrane Separator in Rechargeable Electrochemical Cells”, by Tsepin Tsai, Muguo Chen and Lin-Feng Li, filed Jan. 11, 2000; U.S. Ser. No. 09/943,053 entitled “Polymer Matrix Material”, by Robert Callahan, Mark Stevens and Muguo Chen, filed on Aug. 30, 2001; and U.S. Ser. No. 09/942,887 entitled “Electrochemical Cell Incorporating Polymer Matrix Material”, by Robert Callahan, Mark Stevens and Muguo Chen, filed on Aug. 30, 2001; all of which are incorporated by reference herein in their entireties. Other electrolytes may instead be used, however, depending on the capabilities thereof, as will be obvious to those of skill in the art.

The gelling agent for the anode paste may be any suitable gelling agent in sufficient quantity to provide the desired consistency of the paste. The gelling agent may be a crosslinked polyacrylic acid (PAA), such as the Carbopol® family of crosslinked polyacrylic acids (e.g., Carbopol® 675) available from BF Goodrich Company, Charlotte, N.C., Alcosorb® G1 commercially available from Allied Colloids Limited (West Yorkshire, GB), and potassium and sodium salts of PAA, having weight basis average molecular weights of about 2,000,000 to about 5,000,000, preferably about 3,000,000 or about 4,000,000; carboxymethyl cellulose (CMC), such as those available from Aldrich Chemical Co., Inc., Milwaukee, Wis.; hydroxypropylmethyl cellulose; gelatine; polyvinyl alcohol (PVA); poly(ethylene oxide) (PEO); polybutylvinyl alcohol (PBVA); combinations comprising at least one of the foregoing gelling agents; and the like. Generally, the gelling agent concentration (in the base solution without metal) is from about 0.1% to about 50% preferably about 1% to about 10%, and more preferably about 2% to about 3%.

The anode current collector may be any electrically conductive material capable of providing electrical conductivity and optionally capable of providing or enhancing mechanical support to the anode 12. The current collector may be in the form of a mesh, porous plate, metal foam, strip, wire, plate, or other suitable structure. The current collector may be formed of various electrically conductive materials including, but not limited to, copper, ferrous metals such as stainless steel, nickel, chromium, titanium, and the like, and combinations and alloys comprising at least one of the foregoing materials.

An optional additive may be provided to prevent corrosion. Suitable additives include, but are not limited to, polysaccharide, sorbitol, petroleum, mineral, or animal oils; indium oxide; alkali polyacrylate, ascorbic acid; the like; and derivatives, combinations and mixtures comprising at least one of the foregoing additives. However, one of skill in the art will determine that other additive materials may be used.

The oxygen supplied to the cathode 14 may be from any oxygen source, such as air; scrubbed air; pure or substantially oxygen, such as from a utility or system supply or from on site oxygen manufacture; any other processed air; or any combination comprising at least one of the foregoing oxygen sources.

Cathode 14 may be a conventional air diffusion cathode, for example generally comprising an active constituent and a carbon substrate, along with suitable connecting structures, such as a current collector. Typically, the cathode catalyst is selected to attain current densities in ambient air of at least 20 milliamperes per squared centimeter (mA/cm²), preferably at least 50 mA/cm², and more preferably at least 100 mA/cm². Of course, higher current densities may be attained with suitable cathode catalysts and formulations. The cathode may be a bi-functional, for example, which is capable of both operating during discharging and recharging. However, utilizing the systems described herein, the need for a bi-functional cathode is obviated, since the third electrode serves as the charging electrode.

The carbon used is preferably be chemically inert to the electrochemical cell environment and may be provided in various forms including, but not limited to, carbon black, carbon flake, graphite, other high surface area carbon materials, or combinations comprising at least one of the foregoing carbon forms.

The cathode current collector may be any electrically conductive material capable of providing electrical conductivity and preferably chemically stable in alkaline solutions, which optionally is capable of providing support to the cathode 14. The current collector may be in the form of a mesh, porous plate, metal foam, strip, wire, plate, or other suitable structure. The current collector is generally porous to minimize oxygen flow obstruction. The current collector may be formed of various electrically conductive materials including, but not limited to, copper, ferrous metals such as stainless steel, nickel, chromium, titanium, and the like, and combinations and alloys comprising at least one of the foregoing materials. Suitable current collectors include porous metal such as nickel foam metal.

A binder is also typically used in the cathode, which may be any material that adheres substrate materials, the current collector, and the catalyst to form a suitable structure. The binder is generally provided in an amount suitable for adhesive purposes of the carbon, catalyst, and/or current collector. This material is preferably chemically inert to the electrochemical environment. In certain embodiments, the binder material also has hydrophobic characteristics. Appropriate binder materials include polymers and copolymers based on polytetrafluoroethylene (e.g., Teflon® and Teflon® T-30 commercially available from E.I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

The active constituent is generally a suitable catalyst material to facilitate oxygen reaction at the cathode. The catalyst material is generally provided in an effective amount to facilitate oxygen reaction at the cathode. Suitable catalyst materials include, but are not limited to: manganese, lanthanum, strontium, cobalt, platinum, and combinations and oxides comprising at least one of the foregoing catalyst materials. An exemplary air cathode is disclosed in copending, commonly assigned U.S. patent application Ser. No. 09/415,449, entitled “Electrochemical Electrode For Fuel Cell”, to Wayne Yao and Tsepin Tsai, filed on Oct. 8, 1999, which is incorporated herein by reference in its entirety. Other air cathodes may instead be used, however, depending on the performance capabilities thereof, as will be obvious to those of skill in the art.

To electrically isolate the anode 12 from the cathode 14, the separator 16 is provided between the electrodes. In the cell 10 herein, the separator 16 is disposed on the anode 12 to at least partially contain the anode constituents.

The separator may be any commercially available separator capable of electrically isolating the anode and the cathode, while allowing sufficient ionic transport therebetween. Preferably, the separator is flexible, to accommodate electrochemical expansion and contraction of the cell components, and chemically inert to the cell chemicals. Suitable separators are provided in forms including, but not limited to, woven, non-woven, porous (such as microporous or nanoporous), cellular, polymer sheets, and the like. Materials for the separator include, but are not limited to, polyolefin (e.g., Gelgard® commercially available from Dow Chemical Company), polyvinyl alcohol (PVA), cellulose (e.g., nitrocellulose, cellulose acetate, and the like), polyethylene, polyamide (e.g., nylon), fluorocarbon-type resins (e.g., the Nafion® family of resins which have sulfonic acid group functionality, commercially available from du Pont), cellophane, filter paper, and combinations comprising at least one of the foregoing materials. The separator 16 may also comprise additives and/or coatings such as acrylic compounds and the like to make them more wettable and permeable to the electrolyte.

In certain embodiments, the separator comprises a membrane having electrolyte, such as hydroxide conducting electrolytes, incorporated therein. The membrane may have hydroxide conducing properties by virtue of: physical characteristics (e.g., porosity) capable of supporting a hydroxide source, such as a gelatinous alkaline material; molecular structure that supports a hydroxide source, such as an aqueous electrolyte; anion exchange properties, such as anion exchange membranes; or a combination of one or more of these characteristics capable of providing the hydroxide source.

For instance, the separator may comprise a material having physical characteristics (e.g., porosity) capable of supporting a hydroxide source, such as a gelatinous alkaline solution coated on a conventional separator described above. For example, various separators capable of providing ionically conducting media are described in: U.S. Pat. No. 5,250,370 entitled “Variable Area Dynamic Battery,” Sadeg M. Faris, Issued Oct. 5, 1993; U.S. application Ser. No. 08/944,507 filed Oct. 6, 1997 entitled “System and Method for Producing Electrical Power Using Metal Air Fuel Cell Battery Technology,” Sadeg M. Faris, Yuen-Ming Chang, Tsepin Tsai, and Wayne Yao; U.S. application Ser. No. 09/074,337 filed May 7, 1998 entitled “Metal-Air Fuel Cell Battery Systems,” Sadeg M. Faris and Tsepin Tsai; U.S. application Ser. No. 09/110,762 filed Jul. 3, 1998 entitled “Metal-Air Fuel Cell Battery System Employing Metal Fuel Tape and Low-Friction Cathode Structures,” Sadeg M. Faris, Tsepin Tsai, Thomas J. Legbandt, Muguo Chen, and Wayne Yao; U.S. Pat. No. 6,190,792 issued Feb. 20, 2001 entitled “Ionically-Conductive Belt Structure for Use in a Metal-Air Fuel Cell Battery System and Method of Fabricating the Same,” Sadeg M. Faris, Tsepin Tsai, Thomas Legbandt, Wenbin Yao, and Muguo Chen; U.S. application Ser. No. 09/116,643 filed Jul. 16, 1998 entitled “Metal-Air Fuel Cell Battery System Employing Means for Discharging and Recharging Metal-Fuel Cards,” Sadeg M. Faris, Tsepin Tsai, Wenbin Yao, and Muguo Chen; U.S. application Ser. No. 09/268,150 filed Mar. 15, 1999 entitled “Movable Anode Fuel Cell Battery,” by Tsepin Tsai and William Morris; U.S. application Ser. No. 09/526,669 filed Mar. 15, 2000 “Movable Anode Fuel Cell Battery,” Tsepin Tsai, William F. Morris, all of which are herein incorporated by reference.

The electrolyte (either within any one of the variations of the separator herein, or as a liquid within the cell structure in general) generally comprises ion conducting material to allow ionic conduction between the metal anode and the cathode. The electrolyte generally comprises hydroxide-conducting materials such as KOH, NaOH, LiOH, RbOH, CsOH or a combination comprising at least one of the foregoing electrolyte media. In preferred embodiments, the hydroxide-conducting material comprises KOH. Particularly, the electrolyte may comprise aqueous electrolytes having a concentration of about 5% ionic conducting materials to about 55% ionic conducting materials, preferably about 10% ionic conducting materials to about 50% ionic conducting materials, and more preferably about 30% ionic conducting materials to about 40% ionic conducting materials.

The gelling agent for the separator membrane may be any suitable gelling agent in sufficient quantity to provide the desired consistency of the material. The gelling agent may be a crosslinked polyacrylic acid (PAA), such as the Carbopol® family of crosslinked polyacrylic acids (e.g., Carbopol® 675) available from BF Goodrich Company, Charlotte, N.C., Alcosorb® G1 commercially available from Allied Colloids Limited (West Yorkshire, GB), and potassium and sodium salts of polyacrylic acid; carboxymethyl cellulose (CMC), such as those available from Aldrich Chemical Co., Inc., Milwaukee, Wis.; hydroxypropylmethyl cellulose; gelatine; polyvinyl alcohol (PVA); poly(ethylene oxide) (PEO); polybutylvinyl alcohol (PBVA); combinations comprising at least one of the foregoing gelling agents; and the like. Generally, the gelling agent concentration is from about 0.1% to about 50% preferably about 2% to about 10%.

In other embodiments of a hydroxide-conducting membrane as a separator, a molecular structure is provided that supports a hydroxide source, such as an aqueous electrolyte. Such membranes are desirable in that conductivity benefits of aqueous electrolytes may be achieved in a self supported solid state structure. In certain embodiments, the membrane may be fabricated from a composite of a polymeric material and an electrolyte. The molecular structure of the polymeric material supports the electrolyte. Cross-linking and/or polymeric strands serve to maintain the electrolyte.

In one example of a conductive separator, a polymeric material such as polyvinyl chloride (PVC) or poly(ethylene oxide) (PEO) is formed integrally with a hydroxide source as a thick film. In a first formulation, one mole of KOH and 0.1 mole of calcium chloride are dissolved in a mixed solution of 60 milliliters of water and 40 milliliters of tetrahydrogen furan (THF). Calcium chloride is provided as a hygroscopic agent. Thereafter, one mole of PEO is added to the mixture. In a second formulation, the same materials for the first formula are used, with the substitution of PVC for PEO. The solution is cast (or coated) as a thick film onto substrate, such as polyvinyl alcohol (PVA) type plastic material. Other substrate materials preferably having a surface tension higher than the film material may be used. As the mixed solvents evaporate from the applied coating, an ionically-conductive solid state membrane (i.e. thick film) is formed on the PVA substrate. By peeling the solid state membrane off the PVA substrate, a solid-state ionically-conductive membrane or film is formed. Using the above formulations, it is possible to form ionically-conductive films having a thickness in the range of about 0.2 to about 0.5 millimeters.

Other embodiments of conductive membranes suitable as a separator are described in greater detail in: U.S. patent application Ser. No. 09/259,068, entitled “Solid Gel Membrane”, by Muguo Chen, Tsepin Tsai, Wayne Yao, Yuen-Ming Chang, Lin-Feng Li, and Tom Karen, filed on Feb. 26, 1999; U.S. patent application Ser. No. 09/482,126 entitled “Solid Gel Membrane Separator in Rechargeable Electrochemical Cells”, by Tsepin Tsai, Muguo Chen and Lin-Feng Li, filed Jan. 11, 2000; U.S. Ser. No. 09/943,053 entitled “Polymer Matrix Material”, by Robert Callahan, Mark Stevens and Muguo Chen, filed on Aug. 30, 2001; and U.S. Ser. No. 09/942,887 entitled “Electrochemical Cell Incorporating Polymer Matrix Material”, by Robert Callahan, Mark Stevens and Muguo Chen, filed on Aug. 30, 2001; all of which are incorporated by reference herein in their entireties.

In certain embodiments, the polymeric material used as separator comprises a polymerization product of one or more monomers selected from the group of water soluble ethylenically unsaturated amides and acids, and optionally a water soluble or water swellable polymer. The polymerized product may be formed on a support material or substrate. The support material or substrate may be, but not limited to, a woven or nonwoven fabric, such as a polyolefin, polyvinyl alcohol, cellulose, or a polyamide, such as nylon. The electrolyte may be added prior to polymerization of the above monomer(s), or after polymerization. For example, in one embodiment, electrolyte may be added to a solution containing the monomer(s), an optional polymerization initiator, and an optional reinforcing element prior to polymerization, and it remains embedded in the polymeric material after the polymerization. Alternatively, the polymerization may be effectuated without the electrolyte, wherein the electrolyte is subsequently included. The water soluble ethylenically unsaturated amide and acid monomers may include methylenebisacrylamide, acrylamide, methacrylic acid, acrylic acid , 1-vinyl-2-pyrrolidinone, N-isopropylacrylamide, fumaramide, fumaric acid, N,N-dimethylacrylamide, 3,3-dimethylacrylic acid, and the sodium salt of vinylsulfonic acid, other water soluble ethylenically unsaturated amide and acid monomers, or combinations comprising at least one of the foregoing monomers. The water soluble or water swellable polymer, which acts as a reinforcing element, may include polysulfone (anionic), poly(sodium 4-styrenesulfonate), carboxymethyl cellulose, sodium salt of poly(styrenesulfonic acid-co-maleic acid), corn starch, any other water-soluble or water-swellable polymers, or combinations comprising at least one of the foregoing water soluble or water swellable polymers. The addition of the reinforcing element enhances mechanical strength of the polymer structure. Optionally, a crosslinking agent, such as methylenebisacrylamide, ethylenebisacrylamide, any water-soluble N,N′-alkylidene-bis(ethylenically unsaturated amide), other crosslinkers, or combinations comprising at least one of the foregoing crosslinking agents. A polymerization initiator may also be included, such as ammonium persulfate, alkali metal persulfates and peroxides, other initiators, or combinations comprising at least one of the foregoing initiators. Further, an initiator may be used in combination with radical generating methods such as radiation, including for example, ultraviolet light, X-ray, γ-ray, and the like. However, the chemical initiators need not be added if the radiation alone is sufficiently powerful to begin the polymerization.

In one method of forming the polymeric material, the selected fabric may be soaked in the monomer solution (with or without the ionic species), the solution-coated fabric is cooled, and a polymerization initiator is optionally added. The monomer solution may be polymerized by heating, irradiating with ultraviolet light, gamma-rays, x-rays, electron beam, or a combination thereof, wherein the polymeric material is produced. When the ionic species is included in the polymerized solution, the hydroxide ion (or other ions) remains in solution after the polymerization. Further, when the polymeric material does not include the ionic species, it may be added by, for example, soaking the polymeric material in an ionic solution. Polymerization is generally carried out at a temperature ranging from room temperature to about 130° C., but preferably at an elevated temperature ranging from about 75° to about 100° C. Optionally, the polymerization may be carried out using radiation in conjunction with heating. Alternatively, the polymerization may be performed using radiation alone without raising the temperature of the ingredients, depending on the strength of the radiation. Examples of radiation types useful in the polymerization reaction include, but are not limited to, ultraviolet light, gamma-rays, x-rays, electron beam, or a combination thereof. To control the thickness of the membrane, the coated fabric may be placed in suitable molds prior to polymerization. Alternatively, the fabric coated with the monomer solution may be placed between suitable films such as glass and polyethylene teraphthalate (PET) film. The thickness of the film may be varied will be obvious to those of skill in the art based on its effectiveness in a particular application. In certain embodiments, for example for separating oxygen from air, the membrane or separator may have a thickness of about 0.1 mm to about 0.6 mm. Because the actual conducting media remains in aqueous solution within the polymer backbone, the conductivity of the membrane is comparable to that of liquid electrolytes, which at room temperature is significantly high.

In still further embodiments of the separator, anion exchange membranes are employed. Some exemplary anion exchange membranes are based on organic polymers comprising a quaternary ammonium salt structure functionality; strong base polystyrene divinylbenzene cross-linked Type I anion exchangers; weak base polystyrene divinylbenzene cross-linked anion exhangers; strong base/weak base polystyrene divinylbenzene cross-linked Type II anion exchangers; strong base/weak base acrylic anion exchangers; strong base perfluoro aminated anion exchangers; naturally occurring anion exchangers such as certain clays; and combinations and blends comprising at least one of the foregoing materials. An exemplary anion exchange material is described in greater detail in U.S. Provisional Patent Application No. 60/307,312 entitled “Anion Exchange Material”, by Muguo Chen and Robert Callahan, filed on Jul. 23, 2001, and incorporated by reference herein. Another example of a suitable anion exchange membrane is described in greater detail in U.S. Pat. No. 6,183,914 and incorporated by reference herein. The membrane includes an ammonium-based polymer comprising (a) an organic polymer having an alkyl quaternary ammonium salt structure; (b) a nitrogen-containing, heterocyclic ammonium salt; and (c) a source of hydroxide anion.

As shown above with respect to FIG. 2, in one embodiment the separator 116 may be formed integrally with a housing 120. However, alternative configurations may be employed. For example, the separator 116 may be adhered to or disposed in ionic contact with one or more surfaces of the housing 120 wherein the housing comprises openings or sufficient porosity to allow fluid and ion transport between the anode and the cathode.

Additionally, a plurality of separators may be employed, such as a separator on the anode housing 120, and a separator on the cathode. Such a configuration may be particularly desirable in a refuelable cell, since the cathode remains protected when the anode housing 120 is inserted and removed, and the anode paste remains intact within the anode housing 120 during insertion and removal.

FIG. 3 is a schematic representation of another embodiment of an electrochemical cell 310, comprising an anode 312 within a housing 320, a cathode 314, and a separator 316 disposed on a surface of the housing 320 adjacent the cathode 314. Additionally, an interface layer 318 is disposed between and in ionic contact with separator 316 and the cathode 314. Anode 312 comprises a current collector 322 and anode paste 324. The current collector 322 is positioned within the anode chamber, and anode paste 324 is filled into the chamber.

The interface 318 generally comprises a gel material applied on at least one major surface of the separator 316 and/or the cathode 314. Alternatively, the interface 318 may comprise an additional membrane or a separator (not shown) having a gel material thereon, which may be the same as or different from the separator 316, may be applied to the cathode. The gel may comprise an ion conducting material such as an alkaline solution containing a gelling agent. The alkaline solution may comprise a solution such as KOH or NaOH. Generally, the base concentration in the solution is about 5% to about 55% base, preferably about 15% to about 45% base, and more preferably about 30% to about 45% base.

The gelling agent may be a crosslinked polyacrylic acid, such as those described with respect to the anode paste, or another gelling agent. These gelling agents include, but are not limited to, the Carbopol® family of crosslinked polyacrylic acids (e.g., Carbopol® 675), Alcosorb® G1, potassium and sodium salts of polyacrylic acid, CMC, hydroxypropylmethyl cellulose, gelatine; PVA, PEO, PBVA, the like, and combinations comprising at least one of the foregoing gelling agents. Generally, the gelling agent concentration in the solution is about 0.1% to about 50% gelling agent, preferably about 1% to about 20% gelling agent, and more preferably about 2% to about 5% gelling agent.

With the inclusion of the interface 318, it is possible to overcome or minimize deficiencies of the prior art wherein an activation process is required. Particularly, the interface 318 allows the cell 310 to operate at desired current levels without requiring a period of low current activation. With the gel material, the air-cathode becomes much more wettable, therefore reducing the impedance between the air-cathode and the electrolyte, and improving the ionic contact between the cathode and the electrolyte. This may be accomplished while minimizing or eliminating cathode leakage and, flooding of the cathode. While not wishing to be bound by theory, it is believed that the interface 318 serves as a bridge agent to wet the cathode surface.

Further, the internal adhesion of the cathode itself may be improved (e.g., where cathode particles may be subject to delaminating from the surface or are loosely packed), as well as the adhesion between the cathode and the separator (thus) minimizing or preventing delamination).

Additionally, the interface 318 contributes to ease of refuelability. The gel material serves as a lubricant for insertion and removal of the anode housing containing paste therein, minimizing the likelihood or preferably preventing adhesion or friction between the anode housing and the cathode.

The gel for interface 318 may further comprise a catalyst material, which may differ depending on which electrode the interface 318 is in contact with. As depicted in FIG. 3, interface 318 is in contact with the cathode 314; therefore, suitable optional catalyst materials may include, but are not limited to: activated carbon, manganese base compounds such as potassium manganate (KMnO₄), manganese oxide (MnO₁₊ₓ, wherein x is between 0 and 1), manganese perovskite such as lanthanum/strontium/manganese oxides (such as (LaₓSr₁₋ₓ)_{y}MnO₃, wherein x is about 0 to about 1 and y is about 0.75 to about 1, e.g., wherein x=0.8 and y=0.98), cobalt or manganese macrocyclic compounds such as tetramethoxyphenolporphyrin (CoTMPP), cobalt phthalocyanine (CoPc), spinel compounds such as MnCo₂O₄, cobalt perovskite such as lanthanum/strontium/cobalt oxides (such as (LaₓSr₁₋ₓ)CoO₃, wherein x is about 0 to about 1 and y is about 0.75 to about 1, e.g., wherein x=0.5 and y=1); silver and platinum including combinations of platinum and a carbon diluent (e.g., about 0.1% to about 20% Pt on Vulcan XC-72 (commercially available from Cabot Corporation, Alpharetta, Ga.)); and combinations comprising at least one of the foregoing catalyst materials.

With the inclusion of one or more suitable catalysts in a catalytically effective amount, the cathode performance, particularly the discharging voltage, may be enhanced. While not wishing to be bound by theory, it is believed that the cathode reaction, identified above as Equation (3), and rewritten below as Equation (5), follows a mechanism wherein the oxygen converts to hydroxide ions via an intermediate hydro-peroxide ion according to the steps of Equations (6) and (7).

O₂+2H₂O+4e→4OH⁻ (5)

Possible Mechanism

O₂+2H₂O+2e→HO₂⁻+OH⁻ (6)

HO₂⁻+2H₂O+2e→3OH⁻ (7)

Based on this mechanism, the above mentioned catalysts within the interface 318 may accelerate these steps.

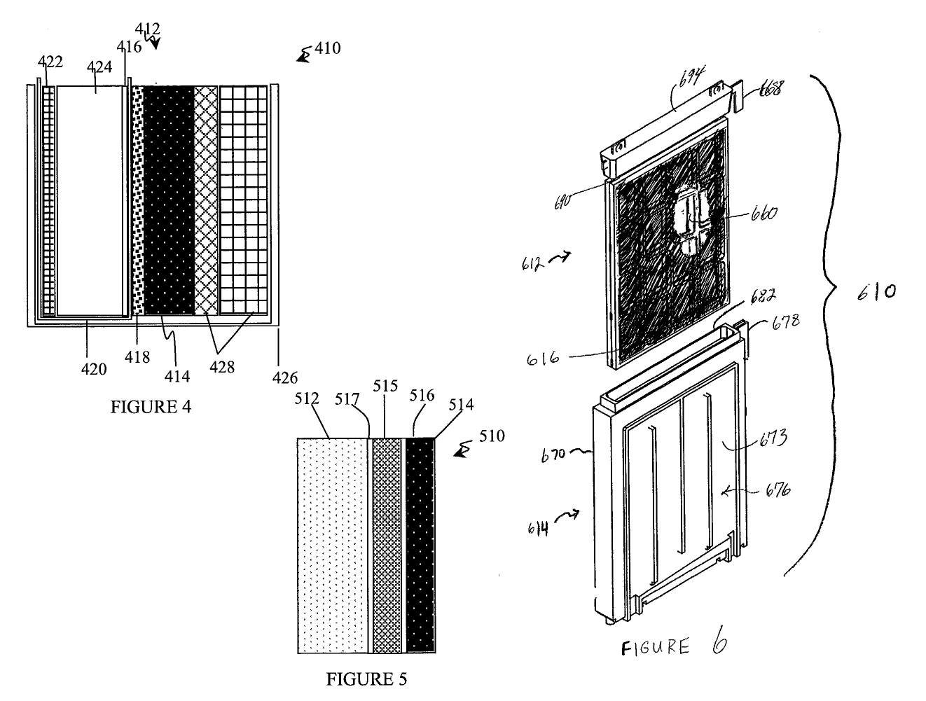

FIG. 4 is a schematic representation of an additional embodiment of an electrochemical cell 410, comprising an anode 412 within an anode housing 420, a cathode 414, and a separator 416. An interface 418 is disposed between and in ionic contact with separator 416 and the cathode 414. Anode 412 comprises a current collector 422 and anode paste 424. A cell housing 426 is provided to house the components of the cell. An air portion 428, for example comprising one or more layers of a perforated or porous material, may be disposed adjacent to the cathode 414, generally to provide air to the cathode, and optionally to impart structural integrity. These layers may comprise materials such as woven, nonwoven, or porous plastics materials. The air portion comprises sufficient porosity to contain a suitable amount of air to react with the cathode 414.

Referring now to FIG. 5, a rechargeable metal air cell 510 is shown. The cell 510 includes an anode 512 and a cathode 514 in ionic contact. Further, a charging electrode 515 is disposed in ionic contact with the anode 512, and electrically isolated from the cathode 514 with a separator 516 and electrically isolated from the anode 512 with a separator 517. Since the charging electrode 515 is present, the cathode 514 may be a mono-functional electrode, e.g., formulated for discharging while the charging electrode 515 is formulated for charging. In operation, consumed anode material (i.e., oxidized metal), which is in ionic contact with the charging electrode 515, is converted into fresh anode material (i.e., metal) and oxygen upon application of a power source (e.g. more than 2 volts for metal-air systems) across the charging electrode 515 and consumed anode material. The charging electrode 515 may comprise an electrically conducting structure, for example a mesh, porous plate, metal foam, strip, wire, plate, or other suitable structure. In certain embodiments, the charging electrode 515 is porous to allow ionic transfer. The charging electrode 515 may be formed of various electrically conductive materials including, but not limited to, copper, ferrous metals such as stainless steel, nickel, chromium, titanium, and the like, and combinations and alloys comprising at least one of the foregoing materials. Suitable charging electrodes include porous metal such as nickel foam metal.

Of course, it is understood that recharging of the anode structure described herein may be accommodated by an external dedicated recharging cell system. Alternatively, after an anode is discharged, the housing may be removed and the anode paste mechanically replaced within the housing. The spend anode paste may be reconverted by electrical recharging.

Referring now to FIG. 6, a monopolar cell structure 610 is depicted showing an anode structure 612 removed from a cathode structure 614. The anode structure 612 includes a separator 616 attached to a housing 620. A cut-away portion shows a grid structure 660 within the housing, to increase mechanical integrity of the anode structure 612, and further to increase lifetime. Of course, the volume of the grid structure 660 should be accommodated to allow for the desired amount of anode paste (not shown in FIG. 6) within the housing 620. The cathode structure 614 includes a support frame 670 having a a top portion 682 configured generally to receive the anode structure 612. Air cathode portions (one of which is shown in FIG. 6) 673 are disposed on opposing sides of the cathode structure 614. The cathode portions 673 may be integrally formed into the frame 670, e.g., by molding, or adhered or otherwise secured to cathode structure 614. Further provided on the cathode structure 614 is a cathode electrical terminal 678, which is electrically connected to the cathode current collectors (not shown). Adjacent the air cathode portions 673 are air management structures 676. In general, the air management structure 676 allows for controlled airflow across the air cathode portion 173 of the cell 610 and also for the air cathode portion in an adjacent cell via a configured opening therein.

The anode structure 620 generally includes an electrically conductive frame 690, a pair of metal fuel support structures or grids 660, and a top seal portion 694. The electrically conductive frame 690 is configured generally as an open rectangle having an electrical terminal 668 extending from a portion of the open rectangle. The top seal 694, as shown, is a wedge-shaped structure. This is particularly useful, for example, when the top seal 694 is formed of an elastic material, thus providing an air-tight seal when inserted into the cathode structure 614. The separator 616 is disposed over the metal fuel material and corresponding grids 660 to electrically isolate the metal fuel and the air cathodes 173, 175.

One method of assembling the anode includes: adhering foil on both sides of conductive frame 690; spreading a desired quantity of metal fuel paste on the foil (wherein the quantity is selected to provide the desired cell capacity while maintaining sufficient distance from the air cathode when the cell is assembled); pressing the grid 660 over the metal fuel material; and adhering separator 616 to the grid. In preferred embodiments, the separator 616 is adhered to the interconnecting portions of the grid for enhanced structural integrity, and also to provide a tight pressure fit preventing delamination of the separator if the metal fuel paste expands during electrochemical reaction. In still another method of assembling the anode, a compressible member is placed in the open portion of the conductive frame prior to attaching the current collector foil. This provides volume accommodation if the anode material expands during electrochemical reaction.

The electrochemical cell detailed herein provides various benefits, including, but not limited to: avoiding electrolyte leakage; (e.g., capable of being refueled at least 2, preferably at least 5, and more preferably at least 10 times under at least 50 mA/cm², preferably at least 100 mA/cm²); depths of discharge (DOD) of at least 40%, preferably at least 60%, more preferably at least 80%; refuelability, for example, and current densities up to about 200 mA/cm², preferably about 400 mA/ cm², with voltages greater than about 0.6 V, preferably greater than about 0.8 V.

Further, the interfacial layer in the metal air electrochemical cell detailed herein (which may also be used in other refuelable cells as described above in the background of the invention, particularly those using solid cards, or other non-refuelable cells where conductivity and wettability enhancement only is desired) provides various benefits, including, but not limited to: improving the ionic contact between the electrolyte and the cathode; increased the adhesion of the separator to the cathode; increase adhesion within the cathode itself; decreasing adhesion and friction between the anode and the cathode in refuelable cells; and increase the cell output voltage, particularly when catalyst is included in the interfacial layer.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. An anode chamber for a metal air electrochemical cell including the anode chamber and a cathode structure, the anode chamber comprising a housing configured and dimensioned to hold a quantity of anode paste including consumable metal particles, a gelling agent, and a base, and a separator attached to at least one surface of the housing, wherein the anode chamber is configured and dimensioned for removal and insertion into the cathode structure.

2. The anode chamber as in claim 1, wherein the metal particles are selected from the group of materials consisting of zinc, calcium, magnesium, ferrous metals, aluminum and combinations and alloys comprising at least one of the foregoing metals.

3. The anode chamber as in claim 1, wherein the gelling agent is selected from the group consisting of crosslinked polyacrylic acid, carboxymethyl cellulose, hydroxypropylmethyl cellulose, gelatine, polyvinyl alcohol, poly(ethylene oxide), polybutylvinyl alcohol, and combinations and blends comprising at least one of the foregoing gelling agents.

4. The anode chamber as in claim 1, wherein the gelling agent is crosslinked polyacrylic acid.

5. The anode chamber as in claim 4, wherein the crosslinked polyacrylic acid is selected from the group consisting of potassium salts of polyacrylic acid, sodium salts of polyacrylic acid, polyacrylic acid having a weight basis average molecular weight of about 3,000,000, polyacrylic acid having a weight basis average molecular weight of about 4,000,000, and combinations and blends comprising at least one of the foregoing gelling agents.

6. A metal air electrochemical cell comprising the anode chamber of claim 1 comprising:
an anode chamber including a housing configured and dimensioned to hold a quantity of anode paste including consumable metal particles, a gelling agent, and a base, and a separator attached to at least one surface of the housing; and
a cathode structure configured and dimensioned to receive the anode chamber, including at least one active cathode portion in ionic communication with the anode paste through the separator when the anode chamber is inserted within the cathode structure,
wherein the anode chamber is configured and dimensioned for removal and insertion into the cathode structure.

7. The metal air electrochemical cell of claim 6, further comprising a charging electrode in ionic communication with the anode chamber.

8. The metal air electrochemical cell as in claim 6, further comprising an ion conducting interface between the separator and the active cathode portion.

9. The metal air electrochemical cell as in claim 8, wherein said interface comprises an ion conducting material and a catalyst.
